(19) United States
(12) Patent Application Publication
(10) Pub. No.: US 2003/0217693 A1
(43) Pub. Date: Nov. 27, 2003

(54) Substrate support assembly having an edge protector

(75) Inventors: Michael B. Rattner, Santa Clara, CA (US); Rolf A. Guenther, Monte Sereno, CA (US); Jeffrey D. Chinn, Foster City, CA (US)

Correspondence Address: Patent Counsel, Applied Materials, Inc., P.O. Box 450A, Santa Clara, CA, 95052, US

(73) Assignee: Applied Materials, Inc.

(21) Appl. No.: 10/267,987

(22) Filed: Oct. 8, 2002

Related U.S. Application Data
(60) Provisional application No. 60/382,472, filed on May 22, 2002.

(51) Int. Cl. B05C 13/00; B05C 21/00

(52) U.S. Cl. 118/500

(57) ABSTRACT

A substrate support assembly for processing a substrate in a processing chamber comprises a substrate carrier having a bottom surface positioned in contact with a substrate support. The substrate carrier has a recess formed into a top surface. The recess has a support surface and a support region between the bottom surface and the support surface. A shadow ring is positioned proximate the substrate carrier to partially shield the support surface of the substrate carrier.

### CROSS REFERENCE TO RELATED APPLICATIONS

This application claims benefit of U.S. provisional patent application serial No. 60/382,472, filed May 22, 2002, which is herein incorporated by reference.

This application contains subject matter that is related to the subject matter of copending application Ser. No.______, filed simultaneously herewith, entitled, “Substrate Carrier for Processing Substrates,” (Attorney Docket Number 6983/DISPLAY/AKT) commonly assigned with the present invention and incorporated herein by reference in its entirety.

### BACKGROUND OF THE DISCLOSURE

1. Field of the Invention

The present invention generally relates to chambers for substrate processing and, more particularly, to a system for adapting a processing chamber for the processing of substrates of various dimensions in a given chamber using a substrate support assembly having a substrate edge protector.

2. Description of the Related Art

Substrate processing, such as semiconductor wafer processing, is typically practiced in an industrial setting by placing a substrate onto a substrate support or chuck, within a processing chamber and performing a variety of processing operations on the substrate. The substrate and substrate support typically have a circular cross-section, and the substrates currently used typically have a diameter of, for example, about eight inches (200 mm) or about twelve inches (300 mm).

However, in the past, substrate processing was often performed on substrates having smaller diameters, and process equipment of the past included chambers that were designed for processing these smaller substrates. While these process chambers of the past are typically no longer used in high production volume, industrial settings, these older chambers are used, for example, to produce smaller quantities of certain types of microelectronic devices. For example, due to budgetary limitations, universities may purchase older processing equipment that processes, for example, four inch diameter or six inch diameter substrates. The types of material structures and devices that may be formed on a small substrate are diverse and include for example, devices for optoelectronic applications, microelectromechanical systems and devices (MEMS), among others.

Once a material structure or device is formed on small substrate, there may be a need for subsequent processing. In particular, there may be a need to perform this subsequent processing in a modern, state-of-the-art, semiconductor wafer processing chamber. Unfortunately, most modern process chambers are now only designed to process substrates having a circular cross-section and a diameter of eight inches or twelve inches.

The above problems are compounded for the formation MEMS devices. This is because the processing of MEMS devices often includes using aggressive etchants to etch deeply into a wafer substrate or in some cases completely through the wafer substrate (i.e. etch-through processing). Etch-through processing is prone to damaging the underlying substrate support or chuck, which is a chamber component that is costly to replace.

Furthermore, since it is difficult to protect the edge of the substrate using conventional etch resist techniques, the aggressive etchants tend to attack the unprotected wafer edge. This exposure of the wafer edge to aggressive etchants is particularly troublesome, because it can generate contaminant particles that may subsequently scratch or contaminate material layers formed on the substrate. In some cases damage to the edge of the wafer may cause the entire substrate to lose mechanical integrity and crumble, thereby destroying the substrate and layers thereon.

Therefore, a need exists for a system that can be used to convert a conventional semiconductor process chamber into one capable of processing substrates of various shapes and dimensions.

### SUMMARY OF THE INVENTION

The invention is a substrate support assembly for supporting a substrate during processing of the substrate in a processing chamber. The substrate support assembly comprises a substrate carrier and a substrate edge protector. The substrate carrier has a bottom surface positioned in contact with a substrate support. The substrate carrier has a recess formed into a top surface. The recess has a support surface for supporting a substrate. The substrate carrier comprises a support region between the support surface and the bottom surface, and the support region may have a thickness less than a depth of the recess. The support region may comprise a porous material to facilitate heat transfer using a heat transfer gas within the thickness of the support region.

The substrate edge protector is, in one embodiment, a shadow ring positioned above the substrate carrier to partially shield the support surface of the substrate carrier. The shadow ring may include one or more protrusions adapted to be positioned proximate to or in contact with a substrate placed within recess of the substrate carrier. The assembly may further comprise interstitial material positioned between a lower surface of the shadow ring and the top surface of the substrate carrier. The interstitial material prevents contact between the top surface of the substrate carrier and a bottom surface of the shadow ring, and therefore prevents particles from being generated that may contaminate the substrate.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic cross-sectional view of a process chamber that can be used for the practice of embodiments of the invention described herein;

FIG. 2 is a schematic close-up, cross-sectional view of a substrate support assembly of the present invention;

FIG. 3 illustrates a top view of one embodiment of the substrate support assembly of the present invention;

FIG. 4 depicts a cross-sectional view of the substrate support assembly of FIG. 3, with the cross-section taken along line 4-4 of FIG. 3;

FIGS. 5a-5b illustrate bottom views of different embodiments of a shadow ring that can be used to practice embodiments of the invention described herein;

FIG. 6 is a cross-sectional view of the shadow ring of the present invention, showing additional features thereof;

FIG. 7 illustrates a close-up, cross-sectional view of substrate support assembly of FIG. 4, and shows additional features thereof,

FIG. 7A depicts a top plan view of an alternate embodiment of a substrate carrier of the present invention; and

FIG. 7B depicts a cross sectional view of the substrate carrier of FIG. 10A.

### DETAILED DESCRIPTION

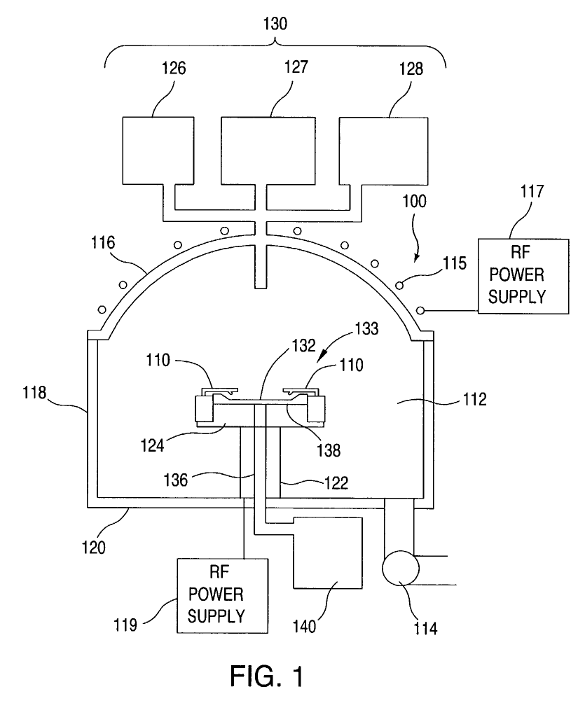

FIG. 1 depicts a schematic, cross-sectional view of an etch processing chamber 100 that can be used for the practice of embodiments of the invention described herein. The etch processing chamber 100 includes a vacuum chamber 112 and a vacuum pump 114 coupled to the vacuum chamber 112. The vacuum chamber 112 is defined by a dome 116 or other form of chamber top, a side wall 118, and a bottom 120. The chamber 112 generally includes a pedestal assembly 123. The pedestal assembly 123 comprises a pedestal 122 and a chuck 124, such as an electrostatic chuck, atop the pedestal 122. The chuck 124 is a conventional chuck typically formed to accommodate substrates having a circular cross section that may be about eight inches (200 mm) or about twelve inches (300 mm) in diameter. A first high frequency power source 119 such as a radio frequency (RF) power source may be coupled to the pedestal 122 in order to capacitively couple RF power to a substrate (not shown) to form a negative bias on the substrate that facilitates etching. A second high frequency power source 117 such as an RF power source may be coupled to at least one antenna 115, in order to control plasma density within the chamber 112. Examples of such an etch processing chamber 100 are the Decoupled Plasma System (DPS I and DPS II) chambers, commercially available from Applied Materials, Inc., Santa Clara, Calif.

A substrate support assembly 133 used to adapt the etch processing chamber 100 for processing substrates of various shapes and sizes is positioned atop the chuck 124. The assembly 133 comprises a substrate carrier 132 and a substrate edge protector that, in one embodiment of the invention is a shadow ring 110. The substrate (not shown) is placed into a recess 154 formed in the substrate carrier 132. A shadow ring 110 is positioned above the substrate carrier 132. Note that the terms “top,” “up,” “down,” “upper,” “lower,” “atop,” and other positional terms are shown with respect to embodiments in the figures and may be varied depending upon the relative orientation of the processing system.

A port 136 may be formed through the pedestal 122 to a top surface 138 of the chuck 124. A thermal fluid, such as an inert gas, flows from a backside gas source 140 to the top surface 138 of the chuck 124. The thermal fluid may be, for example, helium. As is discussed below, the thermal fluid facilitates transferring heat between the substrate and the chuck 124.

The vacuum pump 114 draws a vacuum inside the chamber 112 and facilitates the flow of process gases from one or more gas sources 130 into the chamber 112. In FIG. 1, three gas sources 126, 127, 128 are shown by way of example. The process gases may comprise, for example, a fluorinated gas, such as silicon hexafluoride (SiF₆), hydrogen fluoride (HF), nitrogen trifluoride (NF₃), xenon difluoride (XeF₂), among other fluorinated gases. The process gases may also comprise non-fluorinated gases, for example, methanol (CH₃OH), water vapor (H₂O), argon (Ar) among other non-fluorinated gases. The applied RF power ignites one or more of the process gases into a plasma within the chamber 112 in order to enhance etching of the substrate and/or material layers thereon. Process gases introduced into the chamber 112 from the gas sources 130 are directed to a substrate on the substrate carrier 132 where they may etch various material layers on the substrate. In one embodiment of the invention, at least one of the process gases, such as, for example, one of the fluorinated gases, is excited into a plasma state in a remote plasma chamber (not shown) prior to entering the chamber 112 and is thereafter directed towards the substrate.

Substrate Support Assembly

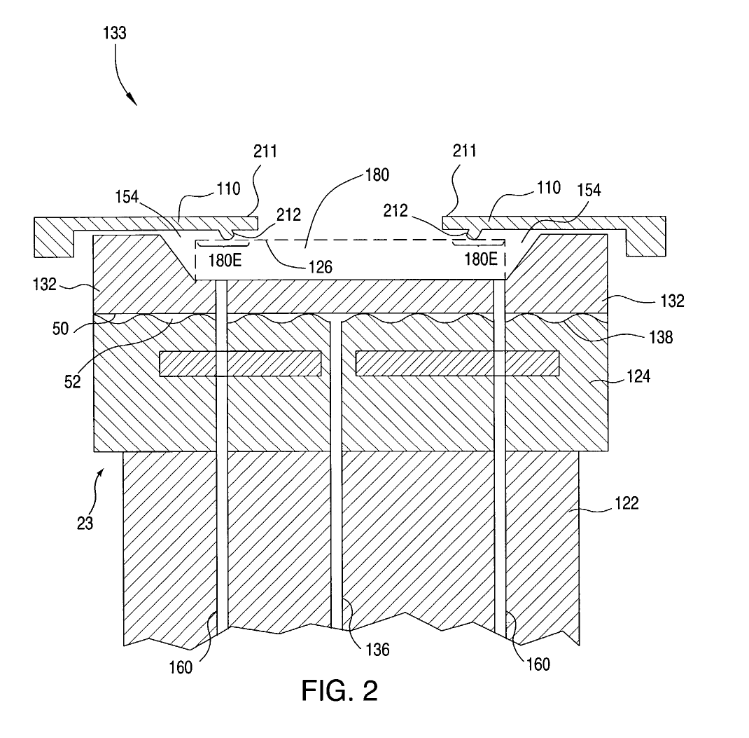

FIG. 2 illustrates a close-up cross-sectional view of the substrate support assembly of the present invention positioned upon the pedestal assembly 123. The substrate carrier 132 is supported on the electrostatic chuck 124 of the pedestal assembly 123. The shadow ring 110 is positioned above the substrate support 132. The pedestal assembly 123 generally comprises the pedestal 122 and the chuck 124. The chuck 124, for example, an electrostatic chuck, sits atop the pedestal 122, and the pedestal 122 and the chuck 124 may have a port 136 therethrough for transporting a thermal fluid to the top surface 138 of the chuck 124. While FIG. 2 depicts one central port, there may be a plurality of ports 136 configured in various arrangements so as to transport the thermal fluid to the top surface 138 of the chuck 124. The pedestal 122 and the chuck 124 may include one or more optional channels 160 through which lift pins (not shown) may project in order to raise and lower the substrate carrier 132 within the chamber 112. Alternatively, the optional channels 160 may extend through the substrate carrier 132 to facilitate lifting of a substrate 180 without lifting the substrate carrier 132.

The substrate carrier 132 has a bottom surface 150 that generally contacts the top surface 138 of the chuck 124. A plurality of channels or interstitial spaces 152 located between the top surface 138 of the chuck 124 and the bottom surface 150 of the substrate carrier 132 transport thermal fluid such that thermal fluid contacts at least a portion of the bottom surface 150 of the substrate carrier 132. The substrate carrier 132 has a recess 154 to facilitate the carrying of the substrate 180.

The shadow ring 110 and the substrate carrier 132 are positioned in proximity of one another so as to shadow an edge exclusion zone 180e of substrate 180. The edge exclusion zone 180e is formed by an overhang region 211 of the shadow ring 110. The overhang region 211 overhangs the outer edge of the substrate 180. The shadow ring 110 may include one or more protrusions 212 that extend downward towards the substrate carrier 132 so that the protrusions 212 may be brought into proximity to or in contact with a top surface 126 of the substrate 180. The protrusions 212 may be intermittent “bumps” or a uniform “ridge.”

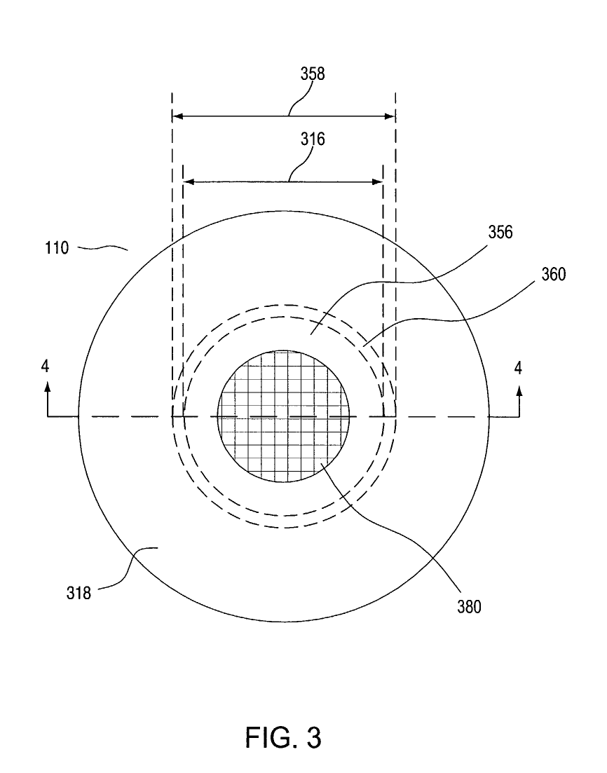

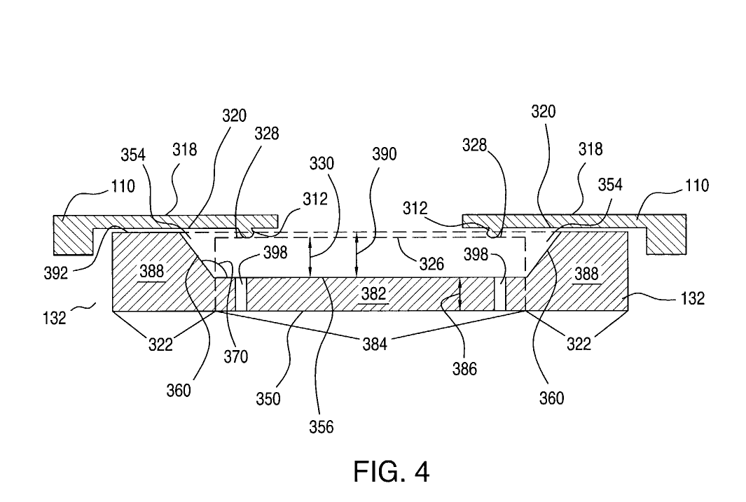

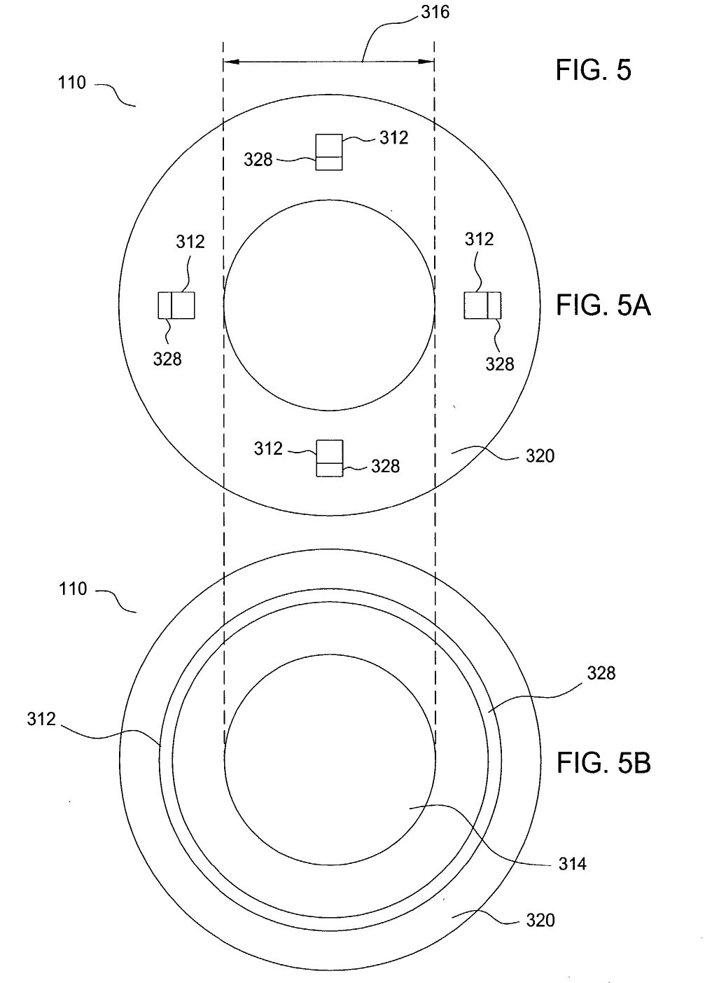

FIG. 3 illustrates a top view of one embodiment of the substrate carrier 132 and the shadow ring 110. FIG. 4 depicts a cross-sectional view of the substrate carrier 132 and the shadow ring 110 of FIG. 3 with the cross-section taken along line 4-4 of FIG. 3. FIGS. 5a-5b illustrate bottom views of different embodiments of the shadow ring 110. To facilitate understanding of the invention, the reader should refer to these drawings as well as FIG. 2, simultaneously while reading the disclosure below.

In general, the substrate carrier 132 has a size and shape that enables a conventional substrate handling robot to carry the substrate carrier 132 and substrate(s) disposed therein, in and out of the chamber 112. The substrate carrier 132 includes a bottom surface 350 that is generally formed to fit on a conventional substrate support such as the substrate support 123 of FIG. 2. The substrate carrier 132 includes a recess 354 that is defined by a support surface 356 and a containment surface 360. The recess 354 has a depth 390. The support surface 356 may be substantially circular, and may have a diameter 358 of about, for example, 4 inches or about 6 inches, and may accommodate substrates having a similar diameter. Rays parallel to the containment surface 360 and the support surface 356 generally define an angle 370 that may be about 90 degrees or greater. In one embodiment of the invention, the angle 370 is about 135 degrees to facilitate placement of a substrate 380 (shown in phantom in FIG. 4) having a thickness 330 within the recess 354 of the substrate carrier 132. The substrate carrier 132 includes a support region 382 that has a cross-section bounded by the support surface 356, a portion 384 of the bottom surface 350, and boundary surfaces 304 (shown in phantom in FIG. 4).

The support region 382 has a thickness 386 that is generally small enough to promote rapid heat transfer from the pedestal 122 and chuck 124 to the substrate 380. The thickness 386 of support region 382 may be less than a depth 390 of the recess 354. In one embodiment of the invention, the thickness 386 of support region 382 may be less than the thickness 330 of the substrate 380 placed within the recess 354. The thickness 386 of the support region 382 is generally large enough to provide mechanical support for the substrate 380 and to allow the substrate carrier 132 to withstand the stresses of both processing and handling of the substrate carrier 132 without cracking or otherwise being damaged. In one embodiment, the thickness 386 of the support region 382 is in the range of about 0.025 centimeters to about 0.13 centimeters.

The substrate carrier 132 also includes outer regions 388 adjacent to support region 382. The outer regions 388 are generally bounded by a top surface 392 that may be substantially parallel to bottom surface 350, an edge surface 320, containment surface 360, a portion 322 of bottom surface 350, and boundary surfaces 304. The outer regions 388 typically have a thickness 394 that is sufficiently large such that the substrate 380 does not extend above the top surface 392. The outer regions 388 typically have a thickness 394 that is sufficiently small such that the substrate carrier 132 does not interfere with the function of other components within the chamber 112. The thickness 394 of the outer regions 388 may be, for example, in the range of about 0.25 centimeters to about 0.65 centimeters.

The support region 382 generally comprises a material that is resistant to degradation when exposed to various environmental conditions within the chamber 112. These environmental conditions may be, for example, temperatures in excess of about 200 degrees Celsius, exposure to high frequency power of up to about 7 watts per square centimeters, and damage from contact with corrosive gases such as fluorinated gases, including hydrogen fluoride (HF).

The support region 382 generally comprises a dielectric material that is capable of maintaining an electrostatic charge on the support surface 356. In this manner, the substrate carrier 132 and the substrate 380 may be held in place on the underlying electrostatic chuck 124. The support region 382 may comprise a material with high thermal conductivity.

In one embodiment of the invention, the support region 382 comprises a ceramic material, such as, for example, silicon carbide. The ceramic material may be formed by various methods, such as, for example, hot isostatic pressing, dry-pressing, among other methods known to the art of ceramics processing. In one embodiment, the ceramic material is formed by fabricating a porous, graphite-based material and partially or completely reacting the graphite-based material to form a silicon carbide material. Products made by this process are available from Poco Graphite Inc., of Decatur, Tex. In another embodiment of the invention, the support region 382 comprises a metallic material having a dielectric coating (not shown) formed thereon. The dielectric coating may comprise, for example, an oxide, a nitride, or other dielectric material. The support region 382 and the outer regions 388 may be formed by pressing a single piece of ceramic material into a desired shape. Alternatively, the support region 382 and the outer regions 388 may be formed as separate units and later joined together by sintering the separate units together or other joining methods known to the art of ceramics or metals processing.

The support region 382 of the substrate carrier 132 may comprise a porous material with open porosity such that a thermal fluid may percolate from the bottom surface 350, through the pores (not shown) in the support region 382, to the support surface 356. The outer regions 388 of the substrate carrier 132 may comprise a ceramic material. In one embodiment of the invention, the outer regions 388 comprise a porous material as described above with reference to support region 382. The outer regions 388 may comprise a densified material with less open porosity than the support region 382. A protective coating (not shown) may be formed on the containment surface 360 and formed on the top face 390 to improve the durability of outer regions 332 by protecting the outer regions 332 from degradation from process gases. The protective coating may comprise, for example, aluminum oxide (Al₂O₃), sapphire, a perfluoroalkoxy material (e.g. Teflon® available from E. I. du Pont de Nemours and Company of Wilmington, Del.), among other materials.

Typically the porosity within the support region 382 is such that no direct line-of-sight path exists between the support surface 356 and the bottom surface 384, i.e., the length of the pores are generally considerably greater than the thickness 386 of support region 382. In other words, the pores are sufficiently tortuous and windy such that the length of the pores is considerably greater than the thickness 386 of the support region 382. This property of the pores is particularly beneficial for the case in which the substrate carrier is used for etch-through processing in which process gases are ignited into a plasma. Because some areas of the substrate 380 may be etched through prior to other areas of the substrate 380, an etch process may be intentionally designed to “over-etch” the substrate 380. In such an etch-through process, aggressive etchant gas that may be traveling, for example, perpendicular to the substrate 380 would be available to travel through the pores to react with, and perhaps damage, the underlying chuck 124. By having tortuous and windy pores with no line-of-sight distance between the bottom surface 350 and the support surface 356, the likelihood of the etchant gas reaching the chuck 124 is reduced or eliminated.

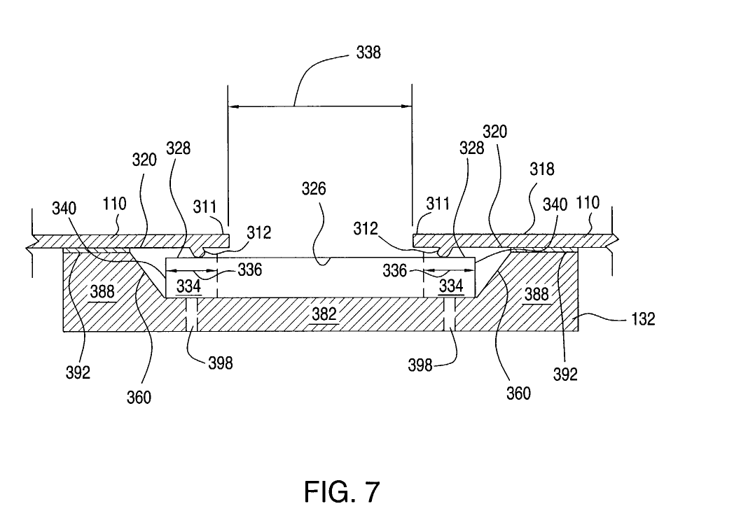

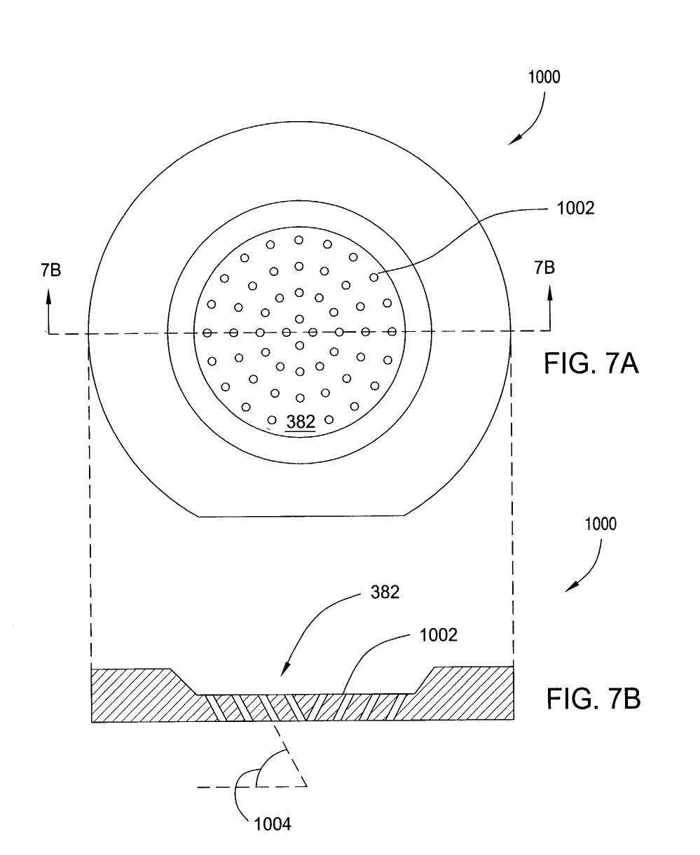

In another embodiment of the invention shown in a top plan view in FIG. 7A and a cross-section view in FIG. 7B, the entire carrier 1000 or only the support region 382 may be fabricated of aluminum. The aluminum is generally anodized. The support region 382 comprises a plurality of channels 1002 drilled through the support region 382 on an angle. The angle 1004 is defined by the thickness of the support region 382 and the need to ensure that the channels do not provide a line of site path through the support region. As such, the top of the angled channel is offset from the bottom of the angled channel such that a vertical path (perpendicular to the surface of the support region) is not possible. Such an angle prevents etchant gases, that generally travel in a path that is perpendicular to the wafer surface, from impacting the surface of the underlying chuck. The channels are sized to enable backside cooling gas (typically helium) to flow from the chuck surface to the backside surface of the substrate. The channel diameter is exaggerated in FIGS. 7A and 7B for clarity.

In another embodiment of the invention, the substrate carrier 132 includes optional channels 398 formed through the support region 382. The optional channels 398 allow lift pins (not shown) to move through the substrate carrier 132 to facilitate the raising and lowering of the substrate 380 within the chamber 112.

The shadow ring 110 is disposed proximate the substrate carrier 132. The shadow ring has an opening 314 with an inner diameter 316. The shadow ring 110 also comprises a shielding surface 318 and a bottom surface 320. The shadow ring 110 may have one or more protrusions 312 that extend downwards from bottom surface 320 and are positioned to face towards the substrate carrier 132. Four protrusions are illustrated by way of example in FIG. 5a. Alternatively, the one or more protrusions 312 may be an annular ridge that extends continuously along bottom surface 320 as shown in FIG. 5b. The one or more protrusions 312 include a contact surface 328 for contacting the substrate 380 disposed within the recess 354 of the substrate carrier 132.

The shadow ring 110 may comprise a material that is resistant to exposure to process gases, including fluorinated gases such as, for example, hydrogen fluoride. The shadow ring may comprise, for example, alumina (Al₂O₃), quartz, silicon carbide (SiC), and the like.

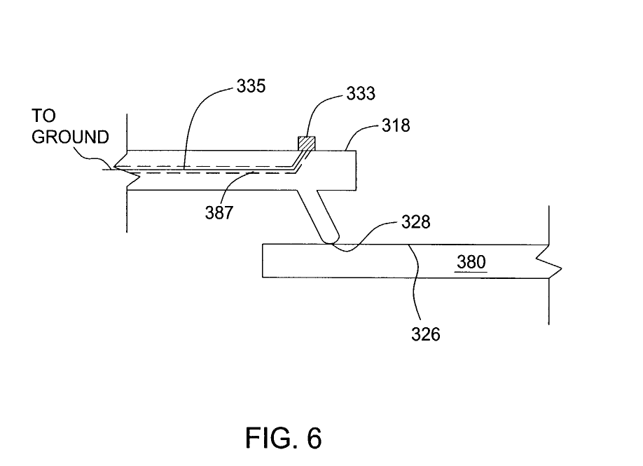

FIG. 6 is a cross-sectional view of the shadow ring 110 showing additional features thereof. The shadow ring 110 may be electrically grounded in order to prevent an accumulation of charge on the shadow ring 110 from interfering with the charge distribution of the plasma within the chamber 100. The shadow ring 110 may be grounded by creating a conductive path from, for example, a point on the top surface 318 of the shadow ring 110 to a grounding surface, such the wall 118 or other grounded surface in the chamber 100. In this embodiment, the shadow ring 110 may have a conductive element 333 that conducts charge away from the top surface 318 of the shadow ring 110. The conductive element 333 may protrude above the top surface 318 of the shadow ring 110. The conductive element 333 may conduct charge from a point on the top surface 318 of the shadow ring 110 by various means. For example, a conductive path 335 (e.g. a wire or other conductor) formed within the shadow ring 110 may conduct charge away from the top surface 318 to ground. The conductive path 335 may be formed or placed within a channel 337 that is within the shadow ring 110.

Upon loading the substrate 380 into the substrate carrier 132, the substrate carrier 132 and the shadow ring 110 are moved into proximity of one another. Generally, the pedestal 123 is raised until the substrate carrier 132 contacts the shadow ring 110. A top surface 326 of the substrate 380 may be brought into contact with the contact surface 328 of the one or more protrusions 312 on the lower surface 320 of the shadow ring 110. Contact between the contact surface 328 of the one or more protrusions 312 with the top surface 326 of the substrate 380 provides a holding force that aids in fixing the position of the substrate 380 within the recess 354 of the substrate carrier 132. The contact force generated is particularly beneficial for embodiments in which the chuck 124, positioned underneath and in contact with the substrate carrier 132, is an electrostatic chuck. This is because the presence of the substrate carrier 132 between the electrostatic chuck 124 and the substrate 380 causes the electrostatic chuck 124 and the substrate 380 to be spaced apart from one another. The electrostatic chucking force holding the substrate 380 in place is thereby reduced. Providing contact between the contact surface 328 of the protrusions 312 of the shadow ring 110 and the top surface 326 of the substrate 380 serves to complement the electrostatic chucking force provided by the electrostatic chuck 124 in order to hold the substrate 380 in place more effectively.

FIG. 7 illustrates a close-up, cross-sectional view of the substrate support assembly of FIG. 4, and shows additional features thereof. An interstitial material 324 may be positioned between the bottom surface 320 of the shadow ring 110 and top surface 392 of substrate carrier 132. The interstitial material 324 may comprise a polymeric material, such as, for example, a polyimide or a polytetrafluoroethylene (e.g., Vespel® or Teflon®, both available from E. I. du Pont de Nemours and Company of Wilmington, Del.). The interstitial material 324 may be a prefabricated component that is inserted between the bottom surface 320 of the shadow ring 110 and the top surface 392 of substrate carrier 132. Alternatively, the interstitial material 324 may be a coating that is formed upon the bottom surface 320 of the shadow ring 110, or the top surface 392 of substrate carrier 132 or both surfaces.

The interstitial material 324 functions to prevent contact between the top surface 392 of the substrate carrier 132 and the bottom surface 320 of the shadow ring 110. Without the interstitial material 324, contact between the top surface 392 of the substrate carrier 132 and the bottom surface 320 of the shadow ring 110 may result in the generation of undesirable particles. The particles generated by the contact of from the top surface 392 of the substrate carrier 132 and the bottom surface 320 of the shadow ring 110 could potentially contaminate the substrate 380 and material layers thereon. Furthermore, particles thus generated may interfere with proper electrostatic chucking of the substrate 380.

An overhang region 311 of the shadow ring 110 provides the substrate 380 with an edge exclusion zone 334 which is generally not subject to processing operations, such as, for example, etching, deposition, and the like that take place in the chamber 112. This is because the edge exclusion zone 334 is generally shadowed from the plasma within the chamber 112, and process operations are confined to a process zone 338 above that portion of the substrate 380 interior to the edge exclusion zone 334. The edge exclusion zone 334 may have a width 336 of, for example, between about 1.5 millimeters and about 3 millimeters.

The edge exclusion zone 334 is of particular importance for embodiments in which a processing operation conducted within the chamber 112 includes etching deeply into the substrate 380 or completely through the substrate 380 (i.e., etch-through processing). Such processing operations typically weaken the substrate 380, causing it to become less mechanically durable. The presence of the edge exclusion zone 334 becomes a region of mechanical strength for the substrate 380 that has been etched, thereby enabling the etched substrate 380 to be handled after the processing with less concern that the substrate will be damaged during handling.

The edge exclusion zone 334 provided by the shadow ring 110 also protects an edge 340 of the substrate 380 from exposure to process gas such as etchant gas. No particles will therefore be generated by etchant gas chemically degrading the edge 340 of the substrate 380. Furthermore, the shadow ring 110 also protects surfaces of the substrate carrier 132 such as the containment surface 360 from being damaged by contact with process gases, such as etchant gases used to process the substrate 380 within the chamber 112.

The substrate support assembly of the present invention exhibits a number of features useful in processing substrates of various shapes and sizes. The substrate carrier 132 accommodates a substrate having a size and/or shape that differs from conventional substrates, such as wafers having a diameter of about eight inches (200 millimeters) or about twelve inches (300 millimeters). The substrate carrier 132 also protects the underlying chuck 124 from being damaged by process gases including aggressive etchant gases that may be used, for example, to etch the substrate 380, such as a silicon wafer. The substrate carrier 132 has a support region 382 that is sufficiently thin to promote rapid thermal transfer from the substrate support 123. The support region 382 may also comprise a porous material that further allows efficient heat transfer across the support region 382 of the substrate carrier 132 by permitting a thermal fluid to percolate through the pores within the support region 382. The substrate carrier 132 also serves to protect the substrate carrier 132 from potential damage due to aggressive etchant gases.

Furthermore, the shadow ring 110 provides an edge exclusion zone 334 that protects the substrate carrier 132 and the chuck 124 from potential damage from process gases. The edge 340 of the substrate 380 is also protected from process gases by the shadow ring 110, thus preventing mechanical degradation of the substrate 380. The protrusions 112 of the shadow ring 110 serve to mitigate any reduction in electrostatic chucking force that may result from the electrostatic chuck 124 from being spaced apart from the substrate 380 by the substrate carrier 132. In addition, the interstitial material 324 prevents contact between the substrate carrier 132 and the shadow ring 110 during substrate loading, and thereby prevents the formation of particles that would interfere with processing operations of the substrate 380. The shadow ring 110 may be electrically grounded in order to prevent undesirable interference with a plasma within the chamber 100.

While the foregoing is directed to the preferred embodiment of the present invention, other and further embodiments of the invention may be devised without departing from the basic scope thereof, and the scope thereof is determined by the claims that follow.

1. A substrate support assembly in a processing chamber, comprising:
a substrate carrier having a bottom surface positioned in contact with a substrate support, the substrate carrier further comprising a top surface opposed to the bottom surface, a recess formed into the top surface, the recess having a support surface that defines a support region for a substrate, where said support region is adapted to contact a bottom of the substrate; and
a shadow ring positioned proximate the substrate carrier to partially shield the support surface of the substrate carrier.

2. The assembly of claim 1 wherein the support region has a thickness less than a depth of the recess.

3. The assembly of claim 1 wherein the shadow ring comprises one or more protrusions adapted to be positioned proximate a substrate placed in the recess of the substrate carrier.

4. The assembly of claim 1 wherein the one or more protrusions includes an annular ridge.

5. The assembly of claim 1 wherein the one or more protrusions include a contact surface for contacting a substrate placed within the recess of the substrate carrier.

6. The assembly of claim 1 further comprising protective interstitial material positioned between a surface of the shadow ring and the top surface of the substrate carrier.

7. The assembly of claim 6 wherein the protective interstitial material is a coating formed on a surface selected from the group consisting of a bottom surface of the shadow ring, the top surface of substrate carrier, and combinations thereof.

8. The assembly of claim 6 wherein the protective interstitial material comprises a polymeric material.

9. The assembly of claim 8 wherein the polymeric material is a polyimide.

10. The assembly of claim 1 wherein the shadow ring comprises a material selected from the group consisting of aluminum oxide, Quartz, SiC, and combinations thereof.

11. The assembly of claim 1 wherein the shadow ring comprises an electrically conductive element for conducting charge from the shadow ring.

12. The assembly of claim 1 wherein the shadow ring comprises a conductive pathway formed therein.

13. A substrate support assembly for processing a substrate in a processing chamber, comprising:
an electrostatic chuck;
a substrate carrier having a bottom surface positioned in contact with the electrostatic chuck, the substrate carrier further comprising a top surface opposed to and substantially parallel to the bottom surface, a recess formed into the top surface, the recess having a support surface that defines a support region for a substrate, where said support region is adapted to contact a bottom of the substrate, and the support surface is substantially parallel to the bottom surface and the top surface; and
a shadow ring positioned proximate the substrate carrier in order to form an edge exclusion zone for a substrate positioned within the recess, the shadow ring comprising one or more protrusions having a contact surface adapted to be positioned in contact with a substrate placed within the recess of the substrate carrier.

14. The assembly of claim 13 wherein the support region has a thickness less than a depth of the recess.

15. The assembly of claim 13 wherein the one or more protrusions includes an annular ridge.

16. The assembly of claim 13 further comprising protective interstitial material positioned between a lower surface of the shadow ring and the top surface of the substrate carrier.

17. The assembly of claim 16 wherein the protective interstitial material is a coating formed on a surface selected from the group consisting of a bottom surface of the shadow ring, the top surface of substrate carrier, and combinations thereof.

18. The assembly of claim 16 wherein the protective interstitial material comprises a polymeric material.

19. The assembly of claim 18 wherein the polymeric material is a polyimide.

20. The assembly of claim 13 wherein the shadow ring comprises a material selected from the group consisting of aluminum oxide, quartz, SiC, and combinations thereof.

21. The assembly of claim 13 wherein the shadow ring comprises an electrically conductive element for conducting charge from the shadow ring.

22. The assembly of claim 13 wherein the shadow ring comprises a conductive pathway formed therein.

23. A method of processing a substrate in a processing chamber, comprising:
moving a substrate carrier having a substrate in a recess disposed therein into a processing chamber;
positioning the substrate carrier and the substrate therein proximate a shadow ring to partially shield the substrate in order to exclude a portion of the substrate from being processed; and
performing a substrate processing operation within the processing chamber.

24. The method of claim 23 wherein the substrate carrier comprises a bottom surface, a top surface opposed to the bottom surface, a recess formed into the top surface, the recess having a support surface that defines a support region for a substrate where said support region is adapted to contact a bottom of the substrate.

25. The method of claim 23 wherein the substrate has a thickness greater than a thickness of the support region.

26. The method of claim 23 wherein the processing operation comprises introducing at least one process gas into the processing chamber and etching the substrate.

27. The method of claim 26 wherein the at least one process gas comprises a gas selected from the group consisting of silicon hexafluoride (SiF₆), hydrogen fluoride (HF), nitrogen trifluoride (NF₃), xenon difluoride (XeF₂), and combinations thereof.

28. The method of claim 23 wherein the shadow ring comprises one or more protrusions, and the one or more protrusions are placed in proximity to the substrate.

29. The method of claim 23 wherein the shadow ring comprises a material selected from the group consisting of aluminum oxide, quartz, silicon carbide (SiC), and combinations thereof.

30. The method of claim 23 further comprising the step of conducting charge from the shadow ring to ground during processing.

31. A method of processing a substrate in a processing chamber, comprising:
moving a substrate carrier having a substrate disposed thereon into a processing chamber;
positioning a shadow ring proximate to the substrate; and
performing a processing operation within the processing chamber,
whereby the shadow ring excludes a portion of the substrate from processing.

32. The method of claim 31 wherein the processing operation comprises introducing a process gas into the processing chamber and etching the substrate.

33. The method of claim 32 wherein the process gas comprises a gas selected from the group consisting of silicon hexafluoride (SiF₆), hydrogen fluoride (HF), nitrogen trifluoride (NF₃), xenon difluoride (XeF₂), and combinations thereof.

34. The method of claim 31 wherein the shadow ring comprises one or more protrusions and the one or more protrusions are placed in contact with the substrate.

35. The method of claim 31 wherein the shadow ring comprises a material selected from the group consisting of aluminum oxide, quartz, silicon carbide (SiC), and combinations thereof.

36. The method of claim 31 wherein a contact surface of the one or more protrusions are placed in contact with the substrate.

37. The method of claim 31 further comprising the step of conducting charge from the shadow ring to ground during processing.

38. The method of claim 31 wherein interstitial material is positioned between the shadow ring and the substrate carrier to prevent contact between the shadow ring and the substrate carrier.
